(19) United States
(12) Patent Application Publication
(10) Pub. No.: US 2002/0090423 A1
(43) Pub. Date: Jul. 11, 2002

(54) Wrist pop

(76) Inventor: Jules Shecter, Boca Raton, FL (US)

Correspondence Address: John C. Smith, Esq., Suite A-207, 4800 North Federal Highway, Boca Raton, FL, 33431, US

(21) Appl. No.: 09/756,436

(22) Filed: Jan. 8, 2001

(51) Int. Cl. A23G 1/00

(52) U.S. Cl. 426/104

(57) ABSTRACT

A candy lollipop head is attached to a wrist band which is worn in the manner of a conventional wrist watch. The wrist pop has one or more candies mounted on it to allow a child to play with the candy before, or during, its consumption. One alternative embodiment provides for a candies shaped in specific forms, such as cartoon characters, or shaped in the form of a device such as a wrist watch face. Another alternative embodiment uses a lollipop head which is attached to a reusable wrist band. A further embodiment uses a disposable wrist pop. An alternative disposable embodiment provides for disposable brackets which are secured to a lollipop head and are then slidably mounted on a reusable wrist band. The wrist band can be fabricated from flexible conventional wrist band's, similar to those used on watches, or wrist band's which are fabricated from snap bracelets.

### BACKGROUND OF THE INVENTION

1. Technical Field

The present invention relates to devices for candies that can be used in combination with, and as part of, a toy. In particular, it relates to a wrist pop that has edible candies mounted on it to allow a child to have a toy and also a piece of candy that can be played with while being eaten.

2. Background Art

A variety of candy devices are known. Dispensers are known which allow solid candies to be individually dispensed to a user. For example, the PEZ (™) dispenser has been in existence for many years. Likewise, dispensers for non-solid candies are also known.

Powdered candies have been distributed in a variety of devices, such as straws, paper containers, etc. Liquid candies have also been widely distributed in many forms. Straws that have removable seals at one or both ends have been used to hold liquid candies. Wax containers have also been used for liquid candies. The wax containers are typically molded in the shape of amusing characters, such as animals, etc.

It is also known to combine candies, such as lollipops, with devices such as flashlights and toy telephones. The purpose of this type of device is that it allows a child to enjoy a lollipop in an entertaining manner. Likewise, the edible candy in this type of device enhances the value of the toy to the child. This type of device requires that the child carry the toy to prevent the candy from becoming soiled or mislaid. It would be desirable to have a combination candy/toy device which did not require the attention of the child at all times.

The prior art has not provided a method of allowing a child to enjoy candy in combination with, and as part of, a toy without requiring that the child spend substantial amounts of care in regard to the candy when handling the device. It would be desirable to have a method of attaching a piece of candy to a toy so that it can be played with by the child prior to, and during, consumption of the candy, and which also did not require a substantial amount of care by the child.

### SUMMARY OF THE INVENTION

The present invention provides an entertaining wrist pop which provides a candy lollipop head attached to a wrist band that is worn in the manner of a conventional wrist watch. The wrist pop has one or more candies mounted on it to allow a child to play with the candy before, or during, its consumption. One alternative embodiment provides for candies shaped in specific forms, such as cartoon, animal characters, etc, or formed in the shape of a device such as a wrist watch face. Another alternative embodiment uses a lollipop head which is attached to a reusable wrist band. A further embodiment uses a disposable wrist pop. An alternative disposable embodiment provides for disposable brackets which are secured to a lollipop head and are then slidably mounted on a reusable wrist band. Wrist band embodiments include flexible conventional wrist band's, similar to those used on watches, or wrist band's which are fabricated from snap bracelets.

### BRIEF DESCRIPTION OF THE DRAWINGS

FIG. 1 is a top view of a preferred embodiment of the invention which illustrates a wrist pop with a single lollipop candy mounted on the top of a disposable bracket attached to a reusable wrist band.

FIG. 2 is a side view of the embodiment of FIG. 1 that illustrates a candy which is formed in the shape of a cartoon character's head.

FIG. 3 is a side view of an alternative preferred embodiment of the invention that illustrates multiple candies mounted on the wrist pop.

FIG. 4 is a side view of an alternative embodiment of the invention that illustrates a candy directly attached to the wrist band of the wrist pop.

FIG. 5 is an alternative preferred embodiment of the invention which illustrates a candy mounted a wrist band which is formed in the shape of a sleeve.

FIG. 6 is a side cutaway view of an alternative embodiment which illustrates a removable candy which is attachable to a reusable bracket.

FIG. 7 is another alternative preferred embodiment in which a removable cover is provided to protect a lollipop while it is not being consumed.

FIG. 8A is another alternative preferred embodiment in which a snap bracelet is used as the wrist band 4. This figure is a side view showing the snap bracelet in the flat/open position

FIG. 8B is the preferred embodiment of FIG. 8A in which the snap bracelet has been moved to the curved/closed position.

### DESCRIPTION OF THE PREFERRED EMBODIMENT

For ease the discussion, the term “lollipop” will be used to refer to either a lollipop, a sucker, or other candy suitable for use as the candy portion of the wrist pop.

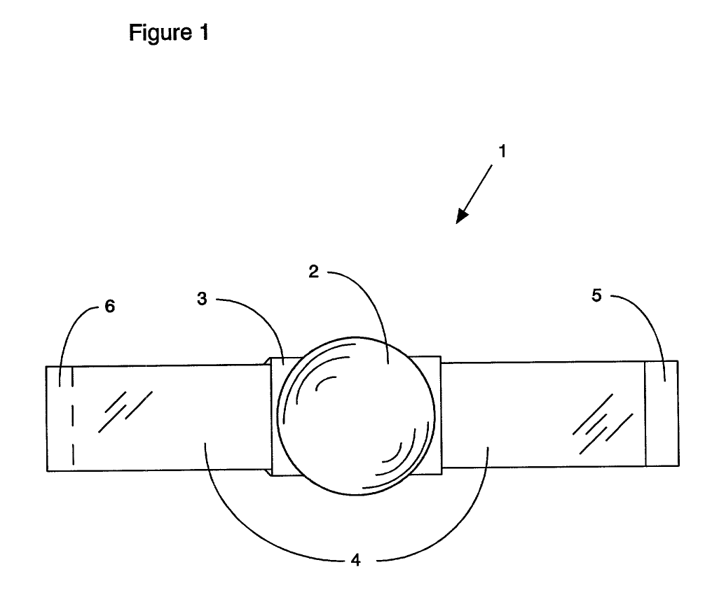

Referring to FIG. 1, this figure shows a top view of a preferred embodiment of the wrist pop 1. In this embodiment, the wrist pop 1 is shaped in a form similar to that of a conventional wrist watch which uses a removable strap. A candy 2 is shown attached to a removable bracket 3. The removable bracket 3, in turn, is attached to a wrist band 4. When used, the child will mount the wrist band 4 to the child's wrist in the same manner that a wrist watch would be secured to the child's wrist. In this illustration, a section of hook and loop material 5 is shown at the distal end of the wrist band 4. When the wrist band 4 is mounted on the child's wrist, the hook and loop material 5 would engage the corresponding section of hook and loop material 6 (indicated by the dash lines) on the proximal end of the wrist band 4.

Those skilled in the art will recognize that just as many different types of devices (buckles, snaps, hook and loop material, buttons, etc) can be used to secure a wrist band on a conventional wrist watch, the same types of devices can also be used to secure the wrist band 4 to the child's wrist. Therefore, the use of and loop material 5, 6 should only be considered as exemplary of a wide variety of available closure devices. Likewise, the candy 2 is shown as a conventional spherical lollipop head. However, it could be shaped in any convenient form, a such as an animal figure, a race car, an airplane, a wrist watch face, etc. While the candy 2 would typically be a sucker or lollipop, it can also be fabricated from any suitable edible material.

The candy 2 is attached to a slidable bracket 3 through which the wrist band 4 is inserted. This embodiment allows a reusable wrist band 4 to be used in conjunction with a disposable bracket 3 which comes with a candy 2 pre-attached. When a candy 2 is consumed, the child can remove the bracket 3 by sliding it off of the wrist band 4 and discarding it. A new candy 2, which comes with a new disposable bracket 3, can then be slidably mounted on the wrist band 4 by inserting the wrist band 4 through the new disposable bracket 3.

The removable bracket 3 allows the candy 2 to be replaced when the candy is consumed, while the wrist band 4 is reused. This reduces the cost of using the wrist pop 1 by allowing the consumer to reuse components of the wrist pop 1.

Those skilled in the art will also recognize that the wrist pop 1 can be constructed as an entirely disposable device by permanently attaching the candy 2 directly to the wrist band 4, or by permanently attaching the candy 2 to the bracket 3 and then permanently attaching the bracket 3 to the wrist band 4. The materials used to fabricate the wrist band 4 and the bracket 3 can be any suitable material. For example, the bracket 3 can be fabricated from plastic, wood, metal, etc. Likewise, the wrist band 4 can be any suitable material, such as fabric, plastic, leather, a conventional metal wrist band, etc.

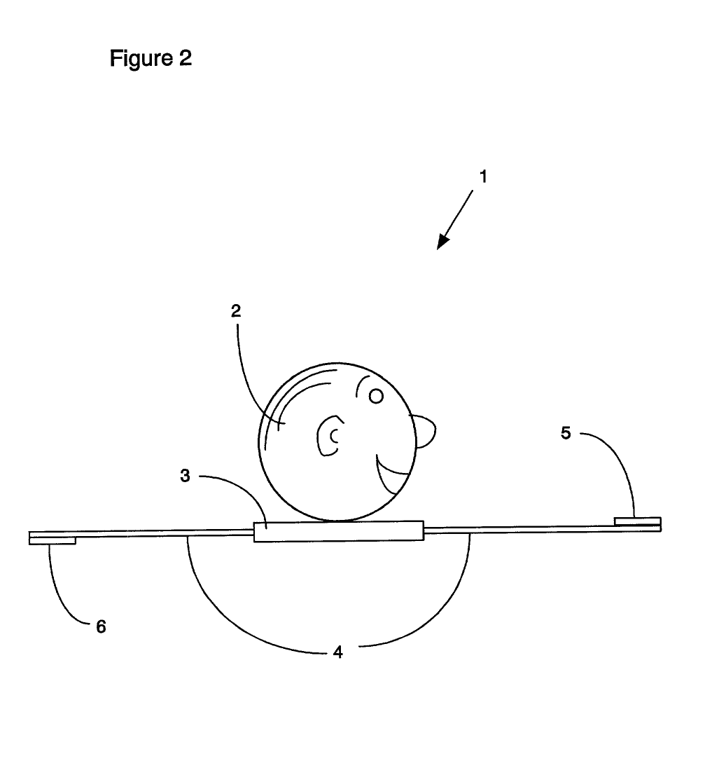

In FIG. 2, a side view of the embodiment of FIG. 1 is shown. In this figure, the hook and loop material 5, 6 are shown on opposite sides of the wrist band 4 and mounted at the distal and proximal ends of the wrist band 4 to allow them to be secured together when worn by the child. The bracket 3 is also shown slidably mounted on the wrist band 4. The candy 2 is shown secured to the bracket 3. Those skilled in the art will recognize that any suitable method of securing the candy 2 to the bracket 3 can be used, such as pressure fittings, edible glues, etc.

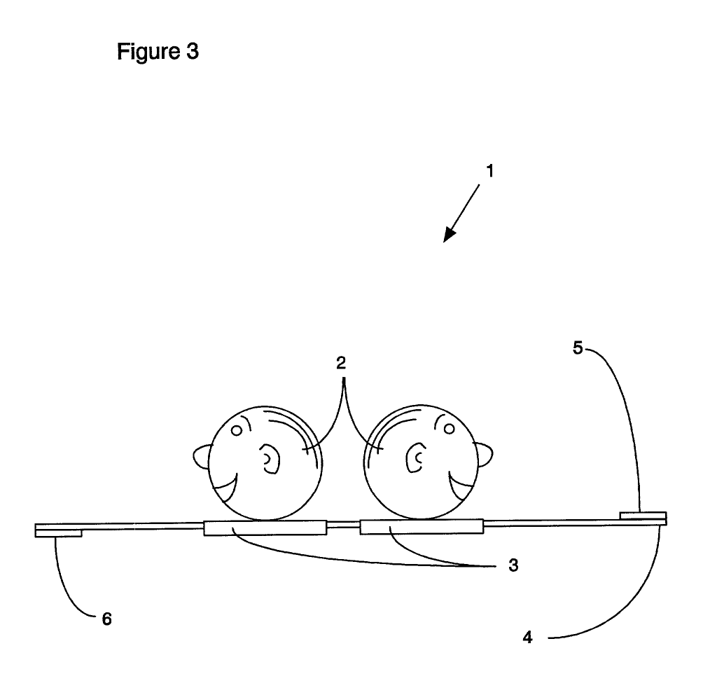

FIG. 3 shows an alternative embodiment in which multiple candies 2 are used with a single wrist pop 1. In this embodiment, the candies 2 are individually mounted on the band 4 of the wrist pop 1. Those skilled in the art will recognize that each candy 2 can have a different flavor to allow the child to enjoy more than one flavor at a time. Also, for ease of illustration, each candy 2 is illustrated as an identical figure. However, those skilled in the art will recognize that each candy 2 can be a different character. Thus allowing a child to act out a story with different characters.

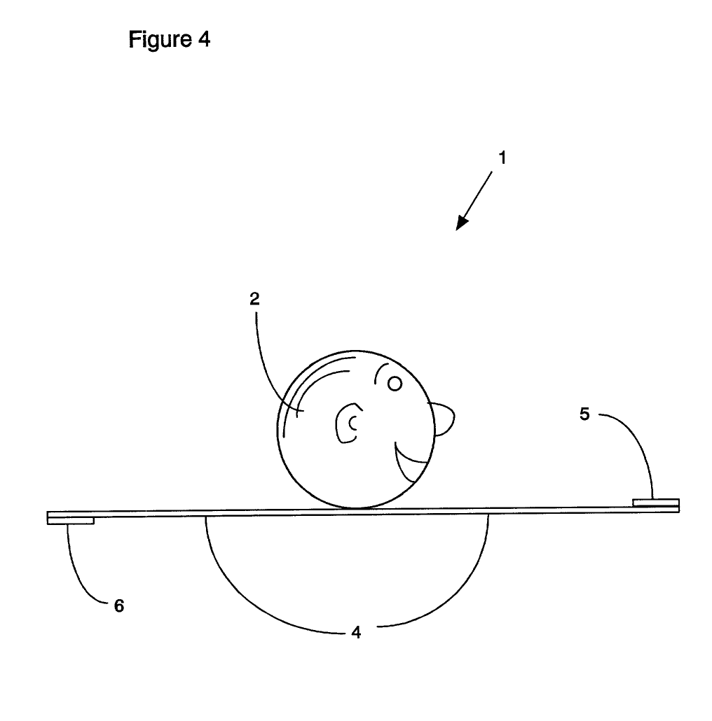

FIG. 4 is a side view of an alternative preferred embodiment in which the candy 2 is directly attached to the wrist band 4. As was the case in the previous embodiments off, the candy 2 can take any desired form. Likewise, the candy 2 can be attached to the wrist band 4 in any suitable manner. This embodiment reduces the cost of fabricating the wrist pop 1 by eliminating the bracket 3 component. However, while this embodiment would typically be disposable, those skilled in the art will recognize that it would also be possible to secure candy 2 directly to the wrist band 4 through the use the edible adhesives, mounting posts, etc.

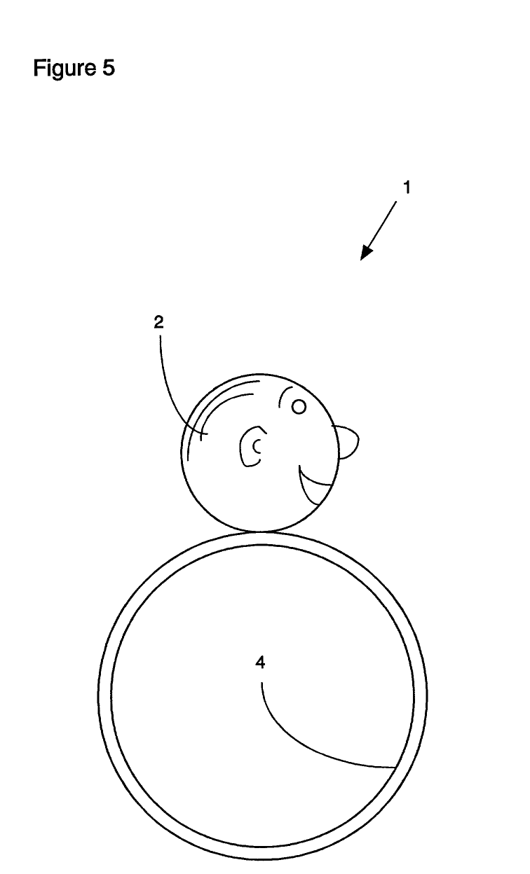

Regarding FIG. 5, this figure shows a side view of an alternative preferred embodiment of the wrist pop 1. In this embodiment, the wrist band 4 is shaped in the form of a flexible sleeve, thereby eliminating the need for securing devices such as hook and loop material 5, 6. Of course, the wrist pop 1 can be constructed such that the candy 2 is directly attached to the wrist band 4, or to a snap on bracket 3 (not shown in this figure). As was the case in the previous embodiments, depending on how the candy 2 is attached to the wrist band 4, the wrist band 4 may or may not be disposable.

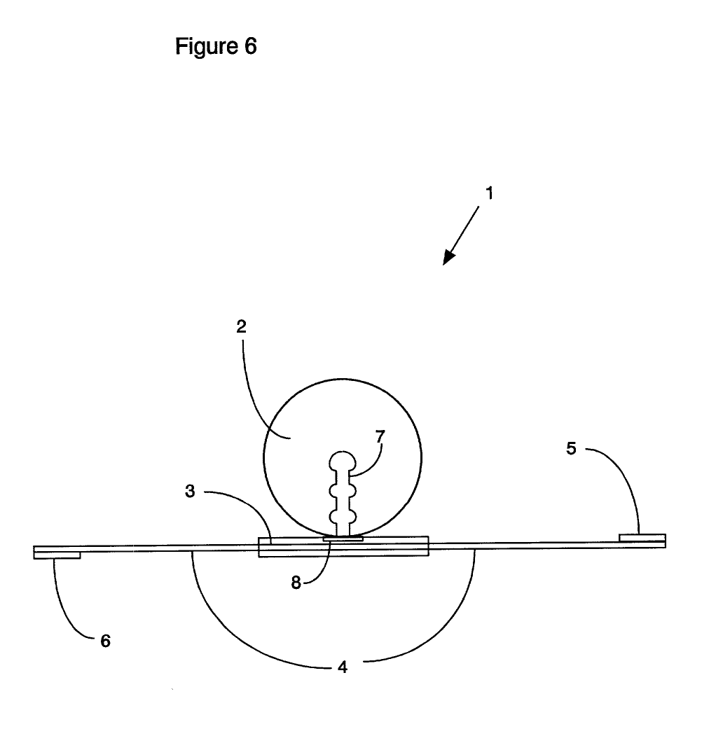

Regarding FIG. 6, this figure shows a side cutaway view of an alternative preferred embodiment which uses replaceable candies that mounted on a reusable bracket. In this view, the wrist pop 1 has a bracket 3 with a pressure fit post 7 which is inserted into a cavity in the lollipop candy 2. This structure allows the user to reuse all of the components of the wrist pop 1 with the exception of the candy 2. Those skilled in the art will recognize that while the pressure fit post 7 illustrates one method of attaching a candy 2 to the wrist pop 1, any suitable attachment means can be utilized to attach the candy 2 to the wrist pop 1.

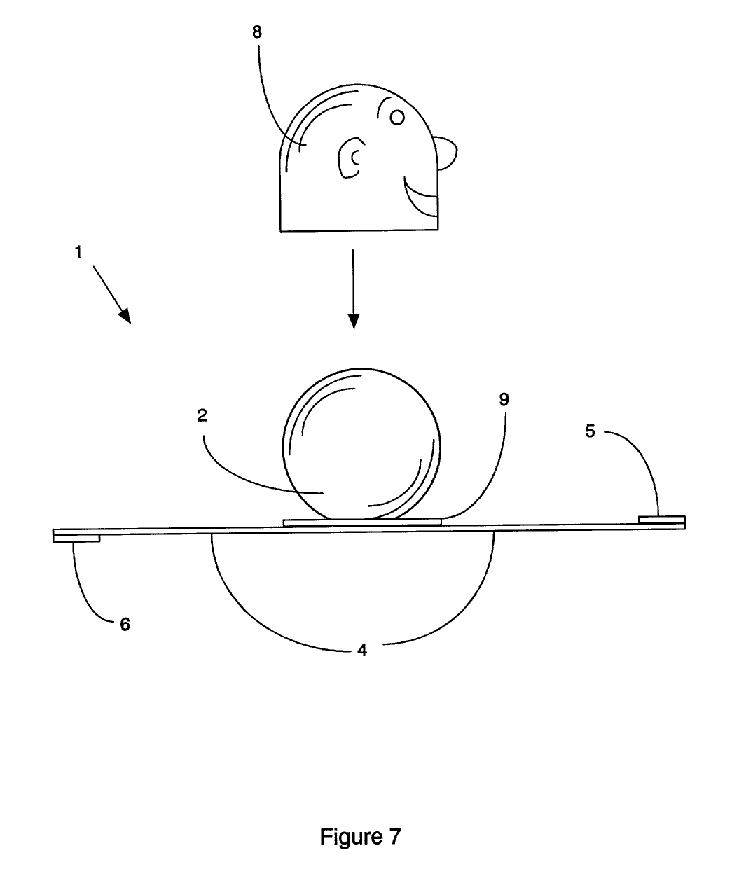

In FIG. 7, an alternative preferred embodiment is shown in which a conventional lollipop candy 2. A removable cover 8 is inserted over the top of the lollipop 2 and has an entertaining character's face which may be the face of a celebrity, etc. The removable cover 8 would preferably be fit onto the cover attachment 9 when the candy 2 is not used. The cover provides an advantage in that it helps keep the candy 2 clean while the child is playing.

Those skilled in the art will recognize that the removable cover 8 can be attached via a pressure fit to the cover attachment 9, can be threaded onto the cover attachment 9, can be hingedly attached to the cover attachment 9, etc. Further, the removable cover 8 can also be constructed in a split form such that it separates to provide access to the lollipop candy 2.

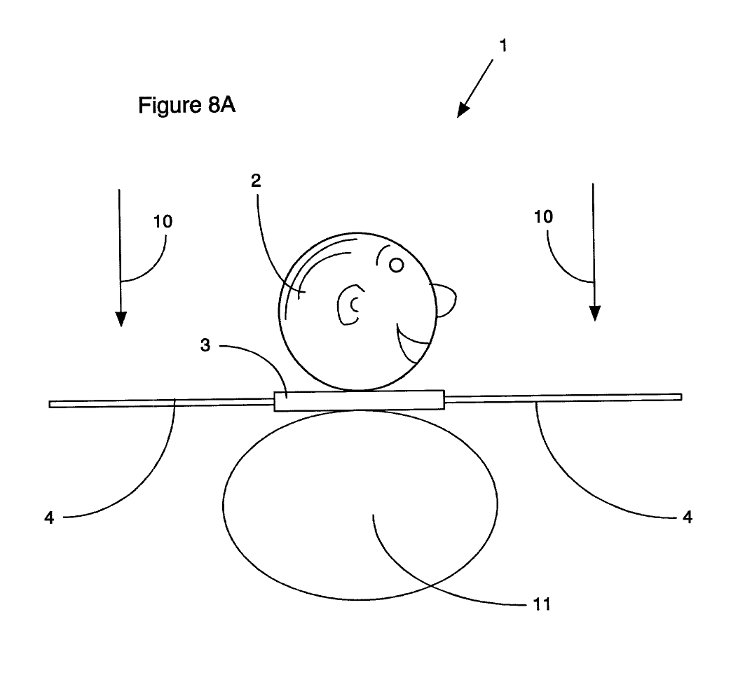

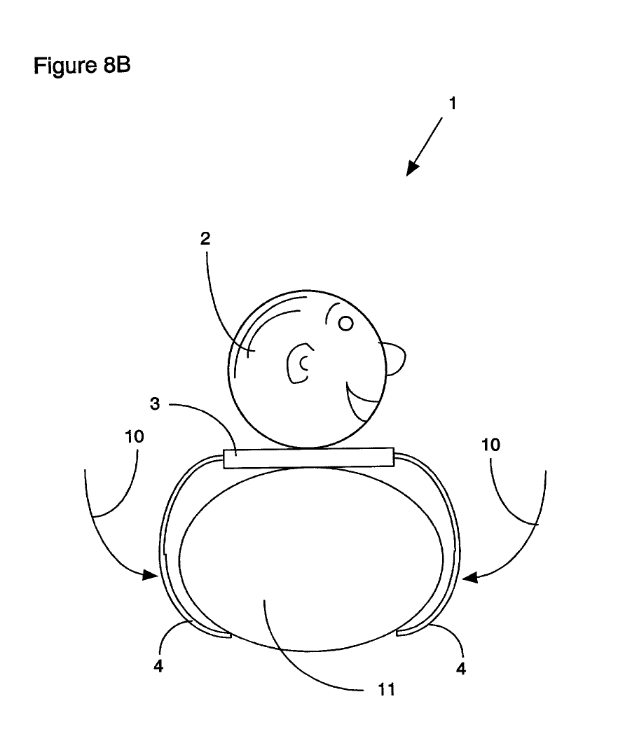

In FIG. 8A, a side view of another alternative preferred embodiment is shown in which the wrist band 4 is fabricated from a snap bracelet. This figure illustrates the snap bracelet in the flat or open position. Force lines 10 illustrate the direction of force that is applied to the wrist band 4 in order to close it when it is resting on the user's wrist 11. A snap bracelets are well-known in the art and are commercially available from a variety of sources.

In FIG. 8B, the embodiment of FIG. 8A is shown after force has been applied to the snap bracelet of wrist band 4 along force lines 10 to move the wrist band 4 from the open to the closed position.

Those skilled in the art will recognize that snap bracelet feature, as well as any of the other features of this invention, can be used in combination with one another.

While the invention has been described with respect to a preferred embodiment thereof, it will be understood by those skilled in the art that various changes in detail may be made therein without departing from the spirit, scope, and teaching of the invention. For example, the material used to construct the wrist band may be any material suitable for the purpose. The bracket may or may not be used, and it may be permanently attached or disposable. The shape of the candy may vary to suit particular ornamental goals, etc., and the candy cover may or may not be used.

1. A novelty candy holder, comprising:
an edible candy;
a wrist band having means to secure itself to a wrist; and
means to secure the candy to the wrist band;
whereby the candy holder can be played with and used as a toy while being consumed.

2. A candy holder, as in claim 1, wherein:
the wrist band is fabricated from a snap band; and
the wrist band has means to secure the edible candy.

3. A candy holder, as in claim 2, wherein:
the edible candy is directly attached to the wrist band.

4. A candy holder, as in claim 2, further comprising:
a bracket, the bracket attached to the wrist band; and
the edible candy is secured to the bracket.

5. A candy holder, as in claim 4, wherein:
the bracket forms a sleeve through which the wrist band is slidably mounted;
whereby the bracket is removably attached to the wrist band.

6. A candy holder, as in claim 5, wherein:
the bracket is disposable.

7. A candy holder, as in claim 5, further comprising:
means to removably attach the bracket to the candy.

8. A candy holder, as in claim 2, further comprising:
means to attach a plurality of candies to the wrist band.

9. A candy holder, as in claim 2, further comprising:
a candy cover, the candy cover having a size suitable to removably fit over the candy, and further having means to removably attach to the wrist band such that when the cover is attached, the candy is enclosed between the candy cover and the wrist band.

10. A candy holder, as in claim 1, wherein:
the wrist band is fabricated from a flexible loop that simply fits around a wrist; and
the wrist band has means to secure the edible candy.

11. A candy holder, as in claim 10, further comprising:
a candy cover, the candy cover having a size suitable to removably fit over the candy, and further having means to removably attach to the wrist band such that when the cover is attached, the candy is enclosed between the candy cover and the wrist band.

12. A candy holder, as in claim 1, further comprising:
means to attach a plurality of candies to the wrist band.

13. A candy holder, as in claim 12, further comprising:
a candy cover, the candy cover having a size suitable to removably fit over the candy, and further having means to removably attach to the wrist band such that when the cover is attached, the candy is enclosed between the candy cover and the wrist band.

14. A candy holder, as in claim 1, wherein:
the wrist band is fabricated from a removable strap; and
the wrist band has means to secure the edible candy.

15. A candy holder, as in claim 14, wherein:
the edible candy is directly attached to the wrist band.

16. A candy holder, as in claim 14, further comprising:
a bracket, the bracket attached to the wrist band; and
the edible candy is secured to the bracket.

17. A candy holder, as in claim 16, wherein:
the bracket forms a sleeve through which the wrist band is slidably mounted;
whereby the bracket is removably attached to the wrist band.

18. A candy holder, as in claim 17, further comprising:
a candy cover, the candy cover having a size suitable to removably fit over the candy, and further having means to removably attach to the wrist band such that when the cover is attached, the candy is enclosed between the candy cover and the wrist band.

19. A candy holder, as in claim 14, wherein:
the removable strap includes book and loop material at distal and proximal ends to secure the wrist band to the wrist.

20. A candy bolder, as in claim 19, further comprising:
a candy cover, the candy cover having a size suitable to removably fit over the candy, and further having means to removably attach to the wrist band such that when the cover is attached, the candy is enclosed between the candy cover and the wrist band.
